(19) United States
(12) Patent Application Publication
(10) Pub. No.: US 2026/0008592 A1
(43) Pub. Date: Jan. 8, 2026

(54) MODIFIED ATMOSPHERE PACKAGING CONTAINER AND METHOD FOR ATTACHING MULTI-LAYERED PEELABLE LINER TO MOLDED FIBER STRUCTURE

(71) Applicant: Cirkla Inc., Lewes, DE (US)

(72) Inventors: Vaibhav Goel, Mumbai (IN); Aniruddha Deshmukh, Mumbai (IN)

(73) Assignee: Cirkla Inc., Lewes, DE (US)

(21) Appl. No.: 19/050,550

(22) Filed: Feb. 11, 2025

Related U.S. Application Data
(63) Continuation-in-part of application No. 29/969,057, filed on Oct. 21, 2024.

(30) Foreign Application Priority Data
Jul. 8, 2024 (IN) 202421052291
Nov. 13, 2024 (IN) 202411087712

(51) Int. Cl. B65D 25/14; B32B 7/06; B32B 27/08; B32B 27/10; B32B 27/30; B32B 27/32; B32B 27/34; B32B 37/06; B32B 37/10; B32B 37/18; B65D 1/34; B65D 77/20; B65D 81/20; B65D 81/26

(52) U.S. Cl. CPC B65D 25/14; B32B 7/06; B32B 27/08; B32B 27/10; B32B 27/306; B32B 27/32; B32B 27/34; B32B 37/06; B32B 37/1018; B32B 37/182; B65D 1/34; B65D 77/2024; B65D 81/2076; B65D 81/264; B32B 2250/05; B32B 2307/7244; B32B 2307/7246; B32B 2307/7376; B32B 2307/748; B32B 2309/02; B32B 2309/04; B32B 2317/12; B32B 2323/04; B32B 2329/04; B32B 2377/00; B32B 2439/02; B32B 2439/70

(57) ABSTRACT

A modified atmosphere packaging (MAP) container, comprising a molded fiber structure that comprises a set of perforations distributed across the molded fiber structure, a multi-layered peelable liner removably attached to a first surface corresponding to a product contact surface of the molded fiber structure. The multi-layered peelable liner comprises a plurality of polyethylene (PE) layers in the range of 40-65 weight percent (wt. %), a plurality of polyamide (PA) layers in the range of 10 to 25 wt. %, and an ethylene vinyl alcohol (EVOH) layer in the range of 5-25 wt. %.

### CROSS-REFERENCE TO RELATED APPLICATIONS/INCORPORATION BY Reference

This Application makes reference to, claims priority to, and claims benefit from Indian Provisional Application No. 202421052291 filed on Jul. 8, 2024. This Application further makes reference to, claims priority to, and claims benefit from Indian Provisional Application No. 20/241,1087712 filed on Nov. 13, 2024. This Application makes reference to, claims priority to, and claims benefit from U.S. design application Ser. No. 29/969,057 filed on Oct. 21, 2024.

The above-referenced Applications are hereby incorporated herein by reference in their entirety.

### FIELD OF TECHNOLOGY

The present disclosure generally relates to the field of environment-friendly packaging solutions, and more specifically, to a modified atmosphere packaging (MAP) container and a method for attaching a multi-layered peelable liner to a molded fiber structure of the MAP container.

### BACKGROUND

Environmental concerns regarding packaging materials have become increasingly prominent in recent years. The packaging industry, particularly the food sector, is one of the largest consumers of plastics globally. This extensive use of non-biodegradable materials has contributed significantly to environmental pollution, as these materials persist in the environment for extended periods, eventually breaking down into microplastics that can enter the food chain through various pathways, including marine life consumption. The food packaging industry faces multiple challenges in its pursuit of sustainable solutions. Traditional packaging materials, while effective, contribute to environmental degradation through their production, use, and disposal. When food products are discarded, their packaging materials often follow the same fate leading to accumulation in landfills and natural environments. The persistence of these materials in the ecosystem has prompted increased scrutiny of food packaging practices and materials.

Modified Atmosphere Packaging (MAP) technology represents a promising solution for extending the shelf life of various food products, including fruits, vegetables, and meat products, to a certain extent. In theory, MAP systems can significantly reduce food waste by maintaining optimal atmospheric conditions around the product. However, practical implementation faces several technical challenges, particularly how to achieve MAP barrier requirements without aggravating the problem of plastic waste.

Further limitations and disadvantages of conventional and traditional approaches will become apparent to one of skill in the art through comparison of such systems with some aspects of the present disclosure, as set forth in the remainder of the present application with reference to the drawings.

### BRIEF SUMMARY OF THE DISCLOSURE

The present disclosure provides a modified atmosphere packaging (MAP) container and a method for attaching a multi-layered peelable liner to a molded fiber structure substantially as shown in and/or described in connection with at least one of the figures, as set forth more completely in the claims.

These and other advantages, aspects and novel features of the present disclosure, as well as details of an illustrated embodiment thereof, will be more fully understood from the following description and drawings.

### BRIEF DESCRIPTION OF THE DRAWINGS

Embodiments of the present disclosure will now be described, by way of example only, with reference to the following diagrams wherein:

FIG. 1 is a diagram illustrating a perspective view of a modified atmosphere packaging (MAP) container, in accordance with an embodiment of the present disclosure;

FIG. 2 is a diagram illustrating a side view of the modified atmosphere packaging (MAP) container, in accordance with an embodiment of the present disclosure;

FIG. 3 is a diagram illustrating a top view of the modified atmosphere packaging (MAP) container, in accordance with an embodiment of the present disclosure;

FIG. 4 is a diagram illustrating a sectional view of the modified atmosphere packaging (MAP) container, in accordance with an embodiment of the present disclosure;

FIG. 5 is a diagram that illustrates attachment of a multi-layered peelable liner to a molded fiber structure, in accordance with an embodiment of the present disclosure;

FIG. 6 is a diagram that illustrates a heating element of the plurality of heating element used in the attachment of a multi-layered peelable liner to a molded fiber structure, in accordance with an embodiment of the present disclosure; and

FIG. 7 is a flowchart that illustrates a method for removably attaching a multi-layered peelable liner to a molded fiber structure, in accordance with an embodiment of the present disclosure.

### DETAILED DESCRIPTION OF THE DISCLOSURE

Certain embodiments of the disclosure may be found in a modified atmosphere packaging (MAP) container and a method for attaching a multi-layered peelable liner to a molded fiber structure of the MAP container. The disclosed MAP container is a specialized container that uses a combination of molded fiber structure (which is environment friendly and biodegradable) and a multi-layered peelable liner to provide an optimal environment for storing food products for extended shelf-life. Conventional MAP containers typically rely solely on plastic materials, such as polyethylene terephthalate (PET), polyvinyl chloride (PVC), or polystyrene (PS), or polypropylene (PP), which contribute to environmental concerns, such as the accumulation of non-biodegradable waste, and the high carbon footprint associated with the production and disposal of synthetic polymers due to the non-biodegradable nature of such materials.

In contrast to the conventional food packaging or conventional MAP containers, the disclosed MAP container addresses such limitations as the conventional MAP containers through its multi-layered peelable liner structure that combines polyethylene, polyamide, and ethylene vinyl alcohol in precisely controlled proportions due to which the required moisture barrier properties are maintained while the oxygen exposure of the food product with the outer environment is also reduced. As a result, the freshness, color, odor, taste, and nutritional level of various food products, especially meat, poultry, seafood, and ready-to-eat meals that require stringent atmospheric control is maintained. Furthermore, the multi-layered peelable liner provides an optimal adhesion strength to ensure that the multi-layered peelable liner provides both secure sealing during use and easy peelability for recycling, thus solving the problem of plastic waste. Hence, the MAP container of the present disclosure maintains the required storage environment while preserving the overall taste, odor, and nutritional levels of food products, thereby extending the shelf life of the food products.

In the following description, reference is made to the accompanying drawings, which form a part hereof, and which are shown, by way of illustration, various embodiments of the present disclosure.

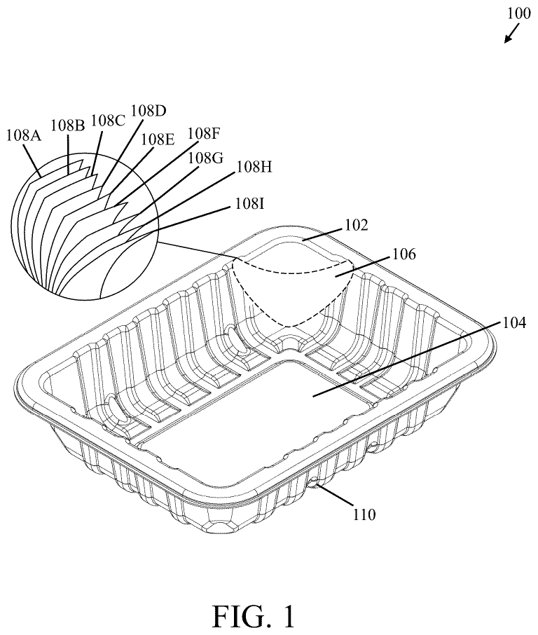

FIG. 1 is a diagram illustrating a perspective view of a modified atmosphere packaging (MAP) container, in accordance with an embodiment of the present disclosure. With reference to FIG. 1, there is shown the MAP container 100. The MAP container 100 includes a molded fiber structure 102 having a first surface 104 (i.e., product contact surface or top surface) and a second surface 110 (e.g., a bottom surface).

The molded fiber structure 102 of the MAP container 100 includes a set of perforations distributed across the molded fiber structure 102. In an implementation, the molded fiber structure 102 refers to a base of the MAP container 100, which can be molded in various structures, such as triangular, rectangular, square, oval, round, polygonal, and the like without affecting the scope of the present disclosure. Additionally, the set of perforations are configured to provide a pathway for evacuation of the air present between the multi-layered peelable liner 106 and the first surface 104 of the molded fiber structure 102 when the multi-layered peelable liner 106 is removably attached to the first surface 104 of the molded fiber structure 102. This ensures that the multi-layered peelable liner 106 sticks evenly to the first surface 104 of the molded fiber structure 102 without forming air bubbles while attaching the multi-layered peelable liner 106 to the molded fiber structure 102.

In accordance with an embodiment, the molded fiber structure 102 is made from a material that is one of: agro-waste pulp such as bagasse, recycled paper, cardboard, plant-based biodegradable fibers, wood-based biodegradable fibers, or one or more combinations thereof. In an example, the molded fiber structure 102 is made from the agro-waste pulp. In another example, the molded fiber structure 102 is made from the recycled paper and cardboard. In yet another example, the molded fiber structure 102 is made from the wood-based biodegradable fibers. In another example, the molded fiber structure 102 is made from the combination of the agro-waste pulp and the recycled paper and the cardboard. Similarly, the molded fiber structure 102 is made from the combination of the plant-based biodegradable fibers and the wood-based biodegradable fibers, and the like. Furthermore, the manufacturing process involves making a slurry from the pulp to further form a structured pulp resembling the shape of the container and thereafter, drying the structured pulp to form the molded fiber structure 102. By using the material, such as plant-based biodegradable fibers or recycled paper, and the like, the molded fiber structure 102 ensures that the MAP container 100 is fully recyclable and can naturally compostable, thereby minimizing pollution and waste accumulation. Moreover, the use of plant-based biodegradable fibers or recycled paper in the molded fiber structure 102 reduces the environmental degradation along with a reduced reliance on non-renewable resources, such as petroleum-based plastics, and the like.

Furthermore, the MAP container 100 includes the multi-layered peelable liner 106 removably attached to the first surface 104 that corresponds to the product contact surface of the molded fiber structure 102. In an implementation, the first surface 104 may be textured or patterned to ensure stability and reduce the potential movement of the food product within the MAP container 100, which could otherwise result in bruising or contamination. In an implementation, the multi-layered peelable liner 106 is attached to the first surface 104 of the molded fiber structure 102, such as by heating the multi-layered peelable liner 106 and applying a vacuum suction pressure through the set of perforations distributed across the molded fiber structure 102 to cause the heated multi-layered peelable liner 106 to stick tightly to the first surface 104 (i.e., the product contact surface) of the molded fiber structure 102. In an implementation, the multi-layered peelable liner 106 is easily removed from the molded fiber structure 102, such as through a tear strip, a pull tab, and the like. In an implementation, the multi-layered peelable liner 106 may be a nine-layered structure which includes a first layer 108A, a second layer 108B, a third layer 108C, a fourth layer 108D, a fifth layer 108E, a sixth layer 108F, a seventh layer 108G, an eighth layer 108H, and a ninth layer 108I that are combined together to form the multi-layered peelable liner 106.

Furthermore, the multi-layered peelable liner 106 further comprises a plurality of polyethylene (PE) layers in the range of 40-65 weight percent (wt. %). The plurality of PE layers prevents the ingress or egress of moisture through the multi-layered peelable liner 106, while providing heat-sealing capability necessary for attaching the liner to the molded fiber structure 102.

In accordance with an embodiment, each of the plurality of PE layers has a thickness in the range of 9-24 micrometers (μm). Moreover, the thickness of each of the plurality of PE layers maintains the overall durability and flexibility of the multi-layered peelable liner 106. It is observed (described, for example, in Table 1) that if the thickness of the plurality of PE layers is below 9 μm, in that case, it adversely affects the overall mechanical strength of the plurality of PE layers thereby leading to a reduced resistance against tearing or puncturing. Similarly, it is further observed that if the thickness of the plurality of PE layers ranges above 24 μm, then, in that case, the multi-layered peelable liner 106 becomes rigid and may hinders the attachment of the multi-layered peelable liner 106 with the molded fiber structure 102 that further affects the peelability of the multi-layered peelable liner 106. Advantageously, it is experimentally observed that the thickness from 9 μ to 24 μm of each of the plurality of PE layers contributes to preventing the ingress or egress of moisture, thereby protecting the quality, and extending the shelf life of the stored food product.

Furthermore, the multi-layered peelable liner 106 comprises a plurality of polyamide (PA) layers in the range of 10 to 25 wt. %. The plurality of PA layers provides an enhanced resistance to mechanical strength, such as tearing or puncturing, thereby prevents any deformation of the multi-layered peelable liner 106 during handling and transportation. The inclusion of the plurality PA layers in the specified range (i.e., 10-25 wt. %) ensures that the multi-layered peelable liner 106 remains robust and durable without compromising the flexibility of the multi-layered peelable liner 106, which enables the multi-layered peelable liner 106 to maintain structural integrity while conforming to the contours of the molded fiber structure 102 and remain intact to the molded fiber structure 102 during transportation and usage of the MAP container 100.

In accordance with an embodiment, each of the plurality of PA layers has a thickness in the range of 10-15 micrometers (μm). It is observed (described, for example, in Table 1) that if the thickness of the plurality of PA layers is less than 10 μm, the performance of the moisture and gas barriers could be compromised, allowing undesirable substances to permeate inside the MAP container 100, which could degrade the quality of the food product inside. It is further observed that if the thickness of the plurality of PA layers exceeds 15 μm, the flexibility of the multi-layered peelable liner 106 to conform to the molded fiber structure 102 is reduced. Therefore, each of the plurality of PA layers in range from 10-15 μm provides mechanical strength to the multi-layered peelable liner 106 in order to ensure that the multi-layered peelable liner 106 remains puncture-resistant and enables the multi-layered peelable liner 106 to conform properly to the molded fiber structure 102.

Furthermore, the multi-layered peelable liner 106 comprises an ethylene vinyl alcohol (EVOH) layer in the range of 5-25 wt. %. The EVOH layer provides barrier against oxygen and maintains the freshness and quality of the food products stored within the MAP container 100. In an implementation, the EVOH creates strong intermolecular hydrogen bonds between the hydroxyl groups, resulting in a tightly packed and highly impermeable polymer matrix that effectively restricts the passage of oxygen through the multi-layered peelable liner 106. By incorporating the EVOH layer in the specified range (i.e., 5-25 wt. %), the multi-layered peelable liner 106 achieves an enhanced oxygen barrier and thereby significantly extends the shelf life of food products stored in the MAP container 100. In accordance with an embodiment, the EVOH layer has a thickness in the range of 12-22 micrometers (μm). Such a range for the thickness of the EVOH layer provides an effective barrier to oxygen and thereby ensures the freshness of food products stored in the MAP container 100. If the thickness of the EVOH layer is less than 12 μm, the oxygen barrier property of the multi-layered peelable liner 106 could be compromised, leading to potential spoilage of the food product packaged inside the MAP container. Conversely, if the thickness of the EVOH layer is more than 22 μm, the flexibility of the multi-layered peelable liner 106 could be reduced, making the multi-layered peelable liner 106 more difficult to conform to the first surface 104 of the molded fiber structure 102. In an example, the EVOH layer has the thickness of 12 μm. In another example, the EVOH layer has a thickness of 22 μm. In yet another example, the EVOH layer has a thickness of μm. Thus, the specified thickness range (i.e., 12-22 μm) of the EVOH layer optimizes the oxygen barrier properties of the multi-layered peelable liner 106 while ensuring that the multi-layered peelable liner 106 retains sufficient flexibility for effective sealing and food product protection.

Table 1 given below provides an exemplary composition and thickness of various multi-layered peelable liners, which are used to make the multi-layered peelable liner 106. The Table 1 shows the different layers and their arrangement sequence, composition of the different layers, individual layer thickness of the different layers, and total thickness of the multi-layered peelable liner 106. Each layer is made from layers of different materials, such as polyethylene (PE) layer for moisture resistance and seal ability, ethylene vinyl alcohol (EVOH) layer for high oxygen barrier properties, polyamide (PA) layer for mechanical strength and puncture resistance, and tie layers for structural integrity of the multi-layered peelable liner 106. The Table 1 shows the first multi-layered peelable liner that consists of different layers in the sequence of: a first PE layer-a second PE layer-a third PE layer-a fourth PE layer-an EVOH layer-a fifth PE-layer-a sixth PE layer-a seventh PE layer-PE layer. The first multi-layered peelable liner comprises EVOH at 15 wt. % and PE at 85 wt. %. The first multi-layered peelable liner has a total thickness of 80 micrometers (μm). Furthermore, all the PE layers have a thickness of 9 μm and the EVOH layer has a thickness of 12 μm. Similarly, the sequence, composition, total thickness, and individual layer thickness of a second multi-layered peelable liner, a third multi-layered peelable liner, and a fourth multi-layered peelable liner are depicted in the Table 1.

TABLE 1

| | | | Individual |
|---|---|---|---|
| | | Total | layer |
| | | Thickness in | thickness in |
| | Composition of the | Micrometers | Micrometers |
| S. No | different layers | (μm) | (μm) |
| 1 | a first PE layer- a second PE layer- | 80 | 9-9-9-9-12- |
| | a third PE layer- a fourth PE layer- | | 9-9-9-9 |
| | an EVOH layer- a fifth PE- layer- | | |
| | a sixth PE layer- a seventh PE layer- | | |
| | PE layer | | |
| | (EVOH: 15 wt. %, PE: 85 wt. %) | | |
| 2 | a first PE layer- a second PE layer- | 125 | 13-13-13-13- |
| | a third PE layer- a fourth PE layer- | | 19-13-13-13- |
| | an EVOH layer- a fifth PE layer- | | 13 |
| | a sixth PE layer- a seventh PE layer- | | |
| | an eight PE layer | | |
| | (EVOH: 15%, PE: 85%) | | |
| 3 | a first PE layer- a second PE layer- | 150 | 16-16-16-16- |
| | a third PE layer- a fourth PE layer- | | 22-16-16-16- |
| | an EVOH layer- a fifth PE layer- | | 16 |
| | a sixth PE layer- a seventh PE layer- | | |
| | an eight PE layer | | |
| | (EVOH: 15%, PE: 85%) | | |
| 4 | a first PE layer- a second PE layer- | 125 | 20-20-1-13- |
| | a first Tie layer- a first PA layer- | | 18-13-1-20- |
| | an EVOH layer- a second PA layer- | | 20 |
| | a second Tie layer- a third PE layer- | | |
| | a fourth PE layer | | |
| | (PA: 20%, EVOH: 15%, | | |
| | PE: 63%, Tie: 2%) | | |

In accordance with an embodiment, the multi-layered peelable liner 106 further comprises the plurality of intermediate tie layers in the range of 5-10 weight percent (wt. %). The plurality of intermediate tie layers facilitates strong adhesion between dissimilar layers, such as the plurality of PE layers, the plurality of PA layers, and the EVOH layer. Moreover, the plurality of intermediate tie layers is used to prevent delamination or separation of the multi-layered peelable liner 106 from the molded fiber structure 102, such as during handling, transporting, or storing the MAP container. In an implementation, the plurality of intermediate tie layers is made from but not limited to adhesive polymers, such as maleic anhydride-modified polyethylene, ethylene vinyl acetate (EVA), functionalized polyolefins, and the like. In an example, the multi-layered peelable liner 106 further comprises a plurality of intermediate tie layers at 5 wt. %. In another example, the multi-layered peelable liner 106 further comprises a plurality of intermediate tie layers at 10 wt. %. In yet another example, the multi-layered peelable liner 106 further comprises a plurality of intermediate tie layers at 8 wt. %. Therefore, the plurality of intermediate tie layers ensures that the multi-layered peelable liner 106 remains cohesive under various conditions, including high temperature, vacuum pressure, and mechanical stresses.

In accordance with an embodiment, each of the plurality of intermediate tie layers is disposed between one PE layer of the plurality of PE layers and one PA layer of the plurality of PA layers. The dissimilar layers within the multi-layered peelable liner 106, such as the plurality of PE layers, the plurality of PA layers, and the EVOH layer, lack inherent bonding due to the differing chemical compositions and material properties. For example, the plurality of PE layers is non-polar and hydrophobic, which makes the plurality of PE layers resistant to bonding with polar and hydrophilic material, such as the plurality of PA layers or the plurality of EVOH layers. Similarly, the plurality of EVOH layers having an enhanced gas barrier property that differs significantly in polarity and surface energy as compared to both the plurality of PE layers and the plurality of PA layers. Moreover, such difference in the chemical compositions and material properties of the dissimilar layers causes a non-uniform and unstable bond between the dissimilar layers. Thus, the plurality of intermediate tie layers is incorporated between the dissimilar layers as an adhesive interface that maintains the structural integrity and mechanical stress of the MAP container 100.

In accordance with an embodiment, the multi-layered peelable liner is a nine-layered peelable structure in which the plurality of PE layers, the plurality of PA layers, and the EVOH layer are disposed in a sequence of: a first PE layer-a second PE layer-a first intermediate Tie layer-a first PA layer-the EVOH layer-a second PA layer-a second intermediate Tie layer-a third PE layer-a fourth PE layer. The PE layers enhance the flexibility and durability of the multi-layered peelable liner 106, while the PA layers improve the barrier against moisture. The EVOH layer provides a barrier to oxygen, ensuring the freshness and preservation of the food product inside the MAP container 100. The intermediate tie layers ensure proper adhesion between dissimilar materials, such as PE, PA, and EVOH, thereby maintaining the integrity of the multi-layered peelable liner 106 during use. Thus, the combination of the plurality of PE layers, the plurality of PA layers, and the EVOH layer in the specified sequence (i.e., the first PE layer-the second PE layer-the first intermediate Tie layer-the first PA layer-the EVOH layer-the second PA layer-the second intermediate Tie layer-the third PE layer-the fourth PE layer) optimizes the balance between structural strength and performance of the multi-layered peelable liner 106, enabling the multi-layered peelable liner 106 to act as an effective barrier against oxygen, moisture, and other external factors. Additionally, the inclusion of the plurality of intermediate tie layers prevents delamination between the dissimilar layers ensures long-lasting performance of the multi-layered peelable liner 106 as well as the MAP container 100 during storage and transportation of the MAP container 100.

In accordance with an embodiment, the multi-layered peelable liner comprises polyamide (PA) in 20 weight percent (wt. %), polyethylene (PE) in 63 wt. %, ethylene vinyl alcohol (EVOH) in 15 wt. %, and Tie layers in 2 wt. %. The multi-layered peelable liner 106 includes PA in a concentration of 20 wt. %, which enhances the durability of the multi-layered peelable liner 106 and provides mechanical strength to resist punctures or tears during handling and transportation. The inclusion of PE at a concentration of 63 wt. % within the multi-layered peelable liner 106 ensures flexibility and provides a smooth, heat-sealable surface, which is essential for creating a reliable and consistent seal with the 100 MAP container. EVOH is included in the multi-layered peelable liner 106 at a concentration of 15 wt. % as the primary gas barrier layer, offering exceptional resistance to oxygen transmission. The oxygen barrier property of EVOH effectively prevents oxygen ingress within the MAP container 100, which could otherwise lead to oxidation and spoilage of the stored food product 406. Additionally, the multi-layered peelable liner 106 incorporates Tie layers in a concentration of 2 wt. %, which ensures bonding of the different material layers (i.e., PA, PE, and EVOH) together while ensuring structural integrity of the multi-layered peelable liner 106 and preventing delamination during use.

In accordance with an embodiment, a thickness of the multi-layered peelable liner 106 is in the range of 60-160 micrometers Such thickness range of the multi-layered peelable liner 106 provides an optimal balance between flexibility and mechanical strength to the multi-layered peelable liner 106 and ensures that the multi-layered peelable liner 106 remains durable enough to resist tearing or puncturing during handling, transportation, and storage while maintaining sufficient pliability to conform seamlessly to the first surface 104 of the molded fiber structure 102. In an example, the thickness of the multi-layered peelable liner is 60 micrometers. In another example, the thickness of the multi-layered peelable liner is 160 micrometers. In yet another example, the thickness of the multi-layered peelable liner is 150 micrometers. Thus, the multi-layered peelable liner 106 within the thickness range of 60 micrometers to 160 micrometers creates a uniform interface with the lidding film, facilitating a reliable and consistent seal that prevents leakage or contamination of the stored food product. Furthermore, the selected thickness supports the performance of the oxygen barrier layer, such as the EVOH layer, within the multi-layered peelable liner 106, enhancing the ability of the MAP container 100 to maintain the desired modified atmosphere and extend the shelf life of perishable food products. Additionally, the thickness of the multi-layered peelable liner 106 depends on the type of food products stored inside the MAP container 100, as different food products have varying requirements for gas permeability, moisture retention, and physical protection. For example, perishable food products like fresh meat or seafood require a thicker multi-layered peelable liner 106 to provide a robust barrier against oxygen and moisture ingress, which helps in preserving freshness of such perishable food products and prevent spoilage. On the other hand, dry food products or food products with lower sensitivity to oxygen or humidity may require a comparatively thinner multi-layered peelable liner. Moreover, the thickness of the multi-layered peelable liner 106 depends on height (or depth) of the molded fiber structure. For example, a taller (or deeper) molded fiber structure may require a thicker multi-layered peelable liner 106 to ensure uniform adhesion and prevent deformation or tearing during application and use. Conversely, a shorter or shallower molded fiber structure may accommodate a thinner multi-layered peelable liner 106. In an example, a molded fiber structure with a height of 1.25 inch needs a multi-layered peelable liner of 125 micrometers. In another example, a molded fiber structure with a height of 1.7 inch needs a multi-layered peelable liner of 150 micrometers. In yet another example, a molded fiber structure with a height of 2 inches needs a multi-layered peelable liner of 150 micrometers. In another example, a molded fiber structure with a height of 2.5 inch needs a multi-layered peelable liner of 180 micrometers. As a result, by customizing the thickness of the multi-layered peelable liner according to the type of food product stored inside the MAP container 100 and the depth of the molded fiber structure 102, MAP packaging can be optimized to provide an enhanced protection for various food products, such as meat, thereby improving freshness and shelf life while minimizing waste.

In accordance with an embodiment, the thickness of the multi-layered peelable liner 106 is in the range of 120-180 micrometers. Such thickness range of the multi-layered peelable liner 106 provides an optimal balance between flexibility and mechanical strength to the multi-layered peelable liner 106 and ensures that the multi-layered peelable liner 106 remains durable enough to resist tearing or puncturing during handling, transportation, and storage while maintaining sufficient pliability to conform seamlessly to the first surface 104 of the molded fiber structure 102. In an example, the thickness of the multi-layered peelable liner 106 is 120 micrometers. In another example, the thickness of the multi-layered peelable liner is 180 micrometers. In yet another example, the thickness of the multi-layered peelable liner is 145 micrometers. As a result, the multi-layered peelable liner 106 within the thickness range of 120 micrometers to 180 micrometers creates a uniform interface with the lidding film, facilitating a reliable and consistent seal that prevents leakage or contamination of the stored food product. Furthermore, the thickness of the multi-layered peelable liner 106 supports the performance of the oxygen barrier layer, such as the EVOH layer, within the multi-layered peelable liner 106, enhancing the ability of the MAP container 100 to maintain the desired modified atmosphere and extend the shelf life of perishable food products.

In accordance with an embodiment, the multi-layered peelable liner 106 has an adhesion strength ranging from 1 to 5 Newtons (N) per 15 millimeters (mm) when removably attached to the first surface of the molded fiber structure 102. The adhesion strength in the present disclosure refers to the force required to peel the multi-layered peelable liner 106 off the first surface 104 of the molded fiber structure 102 over a specified length of 15 mm. In other words, the adhesion strength ranging from 1 to 5 N is required to peel the multi-layered peelable liner 106 over a length of 15 mm from the molded fiber structure 102. In an example, the multi-layered peelable liner 106 has an adhesion strength of 1 N per 15 mm. In another example, the multi-layered peelable liner 106 has an adhesion strength of 15 N per 15 mm. In another example, the multi-layered peelable liner 106 has an adhesion strength of 7 N per 15 mm. Thus, the adhesion strength ranging from 1 to 5 N per 15 mm of the multi-layered peelable liner 106 ensures the multi-layered peelable liner 106 stays securely attached to the first surface 104 of the molded fiber structure 102 throughout storage and handling, providing protection for the food product package inside the MAP container 100.

In an implementation, the MAP container 100 comprises a plurality of cavities and each cavity from the multiple cavities is configured to hold separate food products or different portions of a single food product. The multiple cavities of the MAP container 100 are arranged in such a way that the MAP container 100 with multiple cavities ensure that the food products packed inside the MAP container 100 are securely contained and protected during transportation and storage. In some implementations, the multiple cavities of the MAP container 100 include various integrated features, such as dividers, ribs, or compartments that provide a physical barrier to prevent movement of the food products within each cavity of the MAP container 100.

The MAP container 100 includes the molded fiber structure 102, made from biodegradable materials, such agro-waste pulp or paper, recycled paper or cardboard, plant-based biodegradable fibers, wood-based biodegradable fibers, and the like, thereby providing an eco-friendly alternative to the conventional MAP containers. Additionally, the molded fiber structure 102 further provides an enhanced mechanical support, shape, and structural integrity to the MAP container 100. The set of perforations disposed throughout the molded fiber structure 102 ensures that the multi-layered peelable liner 106 adheres securely and evenly to the first surface 104 of the molded fiber structure 102 without forming air bubbles between the multi-layered peelable liner 106 and the first surface 104 of the molded fiber structure 102. Moreover, the multi-layered peelable liner 106 in combination with the lidding film is used to maintain a controlled environment by preventing moisture loss and oxygen exposure. Additionally, the plurality of PE layers enhances the flexibility and structural strength of the multi-layered peelable liner 106 while the plurality of PA layers prevents the flow of gases and odor. Similarly, the EVOH layer also restricts the flow of oxygen from the outer environment to the MAP container and vice versa.

Advantageously, the multi-layered peelable liner 106 may be a 9-layer co-extruded film with unique composition of different layers arranged in a defined sequence (e.g., given in Table 1). This unique combination provides an excellent oxygen and water vapor barrier, useful for MAP applications, where it is required to maintain low oxygen levels and prevent moisture ingress to extend the shelf life of food products like meats, poultry, and fresh produce. The EVOH layer in particular is designed to minimize oxygen permeation, preventing oxidation of food products, while the PE layer acts as a moisture barrier, keeping food dry and fresh. This multilayer configuration ensures that the packaging remains airtight and moisture-resistant, ideal for preserving the quality of food overextended periods in MAP conditions.

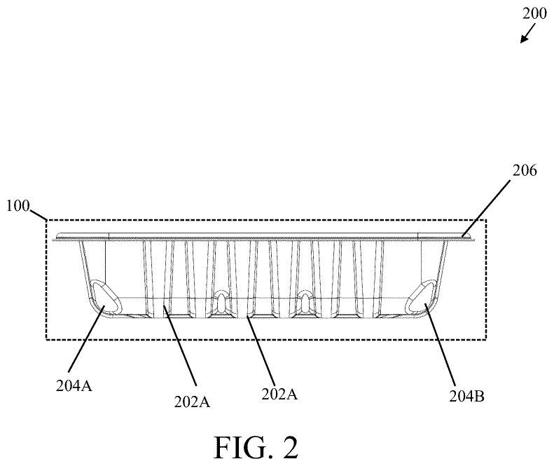

FIG. 2 is a diagram illustrating a side view of the modified atmosphere packaging (MAP) container, in accordance with an embodiment of the present disclosure. FIG. 2 is described in conjunction with the FIG. 1. With reference to FIG. 2, there is shown the side view of 200 of the MAP container 100 that includes a plurality of vertical support members plurality of reinforced corner sections, and a rim profile 206.

In an implementation scenario, the MAP container 100 includes the plurality of vertical support members, such as a first vertical support member 202A, a second vertical support member 202B, and the like that are integrated into the sidewalls of the MAP container 100 configured to provide reinforcement against deformation caused by external forces thereby ensuring that the MAP container 100 maintains original shape while handling, transportation, and storage. Moreover, the plurality of vertical support members includes evenly spaced, elongated ridges or grooves that are extended along the height of the sidewalls of the MAP container 100. Additionally, the vertical orientation of the plurality of vertical support members 202 provides structural stability to the MAP container 100 when stacked, by acting as stabilizing elements and preventing lateral movement or slippage. Furthermore, the MAP container 100 includes the plurality of reinforced corner sections, such as a first reinforcement corner section 204A, a second reinforcement corner section 204B, and the like that is located at the corners of the MAP container 100 to provide added support to the MAP container 100 and enhance the load-bearing capacity of the MAP container 100. Additionally, the reinforced corner sections minimize the risk of deformation or damage to the MAP container 100 under external pressure, thereby maintaining the integrity of the MAP container 100 during handling and storage. In addition, the MAP container 100 further includes the rim profile 206, which is configured to secure sealing with the lidding film. Moreover, the inclusion of the rim profile 206 is used to ensure that the stored food products are effectively isolated from external environmental factors, such as oxygen and moisture, which could compromise the quality of the stored food product. Moreover, the rim profile 206 of the MAP container 100 provides a smooth and consistent surface for selling the MAP container 100. Advantageously, the MAP container 100 provides a robust and reliable solution for preserving, transporting, and storing perishable food products like fruits, vegetables, and meat products. The vertical support members 202 reinforce the sidewalls, preventing deformation during handling and transit. The reinforced corner sections 204 absorb and distribute impact forces, enhancing durability and reducing damage risks. The rim profile 206 ensures a tight, uniform seal between the molded fiber structure 102 and the lidding film, maintaining airtightness and moisture resistance.

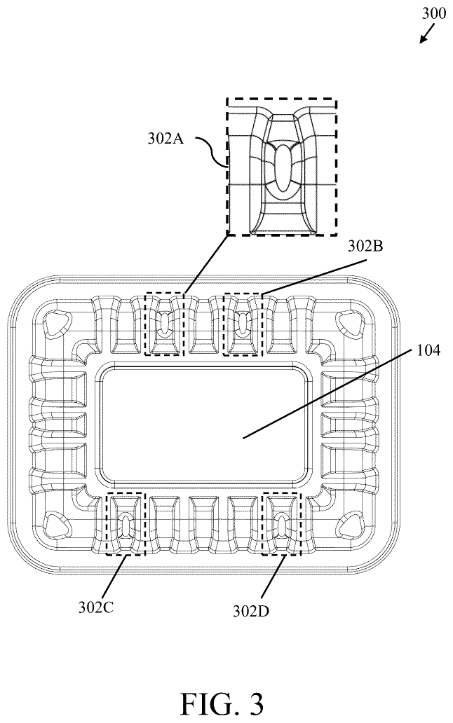

FIG. 3 is diagram illustrating a top view of the modified atmosphere packaging (MAP) container, in accordance with an embodiment of the present disclosure. FIG. 3 is described in conjunction with the FIGS. 1 and 2. With reference to FIG. 3, there is shown the top view 300 of the MAP container 100 that includes the first surface 104 that corresponds to a product contact surface. Furthermore, the MAP container includes a plurality of detesting lugs (i.e., a first denesting lug 302A, a second denesting lug 302B, a third denesting lug 302C, and a fourth denesting lug 302D) formed on the first surface 104 of the molded fiber structure 102.

The plurality of denesting lugs (i.e., the first denesting lug 302A, the second denesting lug 302B, the third denesting lug 302C, and the fourth denesting lug 302D) refers to a set of extending surfaces formed on the first surface 104 of the molded fiber structure 102, which serves as spacers during the stacking and de-stacking of MAP containers. In an implementation, the plurality of denesting lugs includes four different denesting lugs (as shown in FIG. 3), with two lugs formed on two opposite sides of the molded fiber structure in an alternate arrangement. The alternate arrangement of the plurality of denesting lugs helps in stacking and de-stacking of the MAP containers, such that two MAP containers can be stacked in a manner that prevents direct contact between the surfaces of the molded fiber structures, thereby preventing surface-to-surface contact that could lead to sticking, scratching, or damage to the multi-layered peelable liner 106. For example, while stacking a second MAP container over a first MAP container, the second container can be rotated by 180 degrees to ensures that the alternate arrangement of the plurality of denesting lugs of the first MAP container and the second MAP container create a physical separation between the first MAP container and the second MAP container, thereby preventing surface-to-surface contact between the first MAP container and the second MAP container. Furthermore, the top view 300 of the MAP container 100 reveals the rectangular configuration of the MAP container 100 with rounded corners and the distinctive ribbed patterns along all four sides. Moreover, the inclusion of the rounded corners not only enhances the aesthetic appeal of the MAP container 100 but also reduces stress concentration points while minimizing the risk of damage during handling, stacking, and transportation. As a result, the MAP container 100 further includes ribbed pattern that provides additional reinforcement to ensure that the MAP container 100 resist deformation under external forces, such as stacking pressure or impact during transportation, and the like.

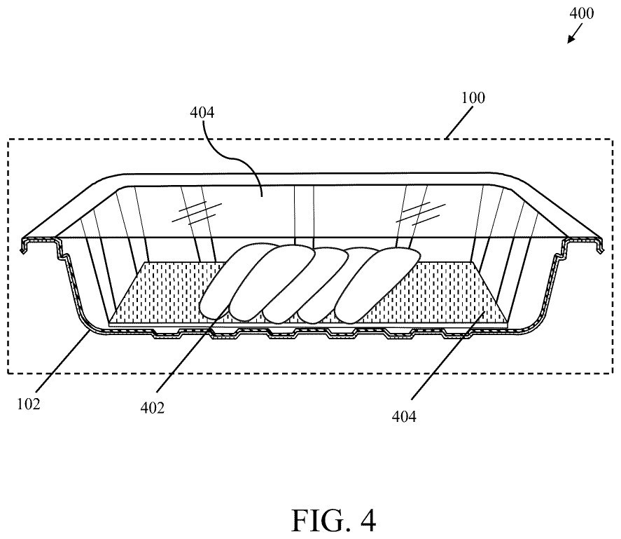

FIG. 4 is a diagram of a sectional view of the modified atmosphere packaging (MAP) container, in accordance with an embodiment of the present disclosure. FIG. 4 is described in conjunction with FIGS. 1 to 3. With reference to FIG. 4, there is show the MAP container 100. The MAP container 100 includes a moisture absorbent pad 402, a lidding film 404, and the molded fiber structure 102.

In an implementation, the food product 406 is stored inside the MAP container 100, which is in contact with the first surface 104 and the multi-layered peelable liner 106 of the MAP container 100. Examples of the food product 406 may include but not limited to vegetables, fruits, meat products, dairy products, poultry products, seafood, ready-to-eat meals, and the like without affecting the scope of the present disclosure. Moreover, the MAP container 100 provides an environment conducive for preserving the freshness, texture, and quality of the stored food product 406 for an extended period of time (e.g., shelf life of 15-45 days for meat products).

In accordance with an embodiment, the MAP container 100 further comprises the lidding film 404 configured to seal the MAP container 100. The lidding film 404 refers to a sealing film that is used to securely enclose the MAP container 100 in order to form an airtight and tamper-evident seal over the MAP container 100 thereby ensuring an improved seal integrity of the MAP container 100. Moreover, the lidding film 404 in combination with the multi-layered peelable liner 106 is used to maintain the moisture level and controlled oxygen exposure, which is required by every food product, especially the meat products stored in the MAP container 100 to improve its shelf life and maintain its taste, color, odor, and the nutritional levels. In an implementation, the lidding film 404 may include multiple layers of barrier materials, such as Linear Low-Density Polyethylene (LLDPE), Ethylene Vinyl Alcohol (EVOH), and the like, which are used to restrict the oxygen ingress and maintains the overall moisture level within the MAP container 100. In an implementation, the lidding film 404 includes easy-peel features to facilitate an easy and user-friendly removal of the lidding film 404 from the top of the MAP container 100 without compromising the seal integrity of the lidding film 404.

In accordance with an embodiment, the MAP container further comprises the moisture absorbent pad 402 disposed on the first surface 104 of the molded fiber structure 102. The moisture absorbent pad 402 refers to a thick layer of high-capacity absorbent materials, such as cellulose fibers, superabsorbent polymers, or other biodegradable composites, which are configured to manage and control excess moisture within the MAP container 100. Moreover, the moisture absorbent pad 402 provides high moisture retention within the MAP container 100 while ensuring that the absorbed moisture remains trapped within the moisture absorbent pad 402 and does not leak out of the MAP container 100. Additionally, the moisture absorbent pad 402 is further configured to absorb the purge, which is the liquid that comes out of meat during storage for a long duration that leads to bacterial growth, unpleasant odors, and potential spoilage of the meat product. In an implementation, the moisture absorbent pad 402 includes an antimicrobial treatment, such as a silver-ion coating or natural antimicrobial agents, such as citric acid derivatives, which inhibit the growth of harmful bacteria that are found in the moist environment. As a result, the moisture absorbent pad 402 is used to maintain the required moisture levels inside the MAP container 100 that enhances the shelf life and freshness of the food product 406 (e.g., meat product).

In accordance with an embodiment, when the food product 406 is stored in the MAP container 100, a combination of the multi-layered peelable liner 106 and the lidding film 404 that seals the MAP container 100 acts as an oxygen barrier and modifies internal atmosphere of the MAP container 100 such that an oxygen transmission rate (OTR) of the MAP container 100 is less than 1 cubic centimeters per square meter per day (cc/m²/day) at a temperature range of 0° C. to 40° C. and a relative humidity range of 10% to 90%. By regulating the oxygen transmission rate inside the MAP container 100, the combination of the multi-layered peelable liner 106 and the lidding film 404 reduces the rate of oxidation thereby extending the shelf life of the food product 406 stored in the MAP container 100. Therefore, the controlled oxygen transmission rate makes the MAP container 100 suitable for a wide range of food products, including the meat products, seafood products, vegetables, fruits, and the like, having different moisture and oxidation rates.

In accordance with an embodiment, when the food product 406 is stored in the MAP container 100, the combination of the multi-layered peelable liner 106 and the lidding film 404 that seals the MAP container 100 acts as a water vapor barrier and modifies internal atmosphere of the MAP container 100 such that a water vapor transmission rate (WVTR) of the MAP container 100 is less than 5 grams per square meter per day at a temperature range of 0° C. to 40° C. and a relative humidity range of 10% to 90%. By regulating the moisture transmission rate within the MAP container 100, the combination of the multi-layered peelable liner 106 and the lidding film 404 reduces the moisture loss from the food product 406 and prevents external moisture from entering the MAP container 100, thereby maintaining the optimal moisture content of the stored food product 406. Therefore, the controlled moisture transmission rate makes the MAP container 100 suitable for a wide range of food products, including the meat products, seafood products, vegetables, fruits, and the like, having different moisture and oxidation rates.

In accordance with an embodiment, when the food product 406 is stored in the MAP container 100, the combination of the multi-layered peelable liner 106 and the lidding film 404 that seals the MAP container 100 acts as a carbon dioxide barrier and modifies internal atmosphere of the MAP container 100 such that a carbon dioxide transmission rate (CO₂TR) of the MAP container 100 is less than 5 grams per square meter per day at a temperature range of 0° C. to 40° C. and a relative humidity range of 10% to 90%. By limiting the transmission of carbon dioxide, the MAP container 100 prevents the accumulation of excessive gas levels inside the MAP container 100 that can negatively affect the texture, taste, or overall quality of the food product 406. As a result, the multi-layered peelable liner 106 and the lidding film 404 that seals the MAP container 100 acts as the carbon dioxide barrier and modifies internal atmosphere of the MAP container 100 is used to maintain the required carbon dioxide levels thereby enhancing the shelf life of the food product 406 while maintaining the freshness, taste, color, and odor of the food product 406.

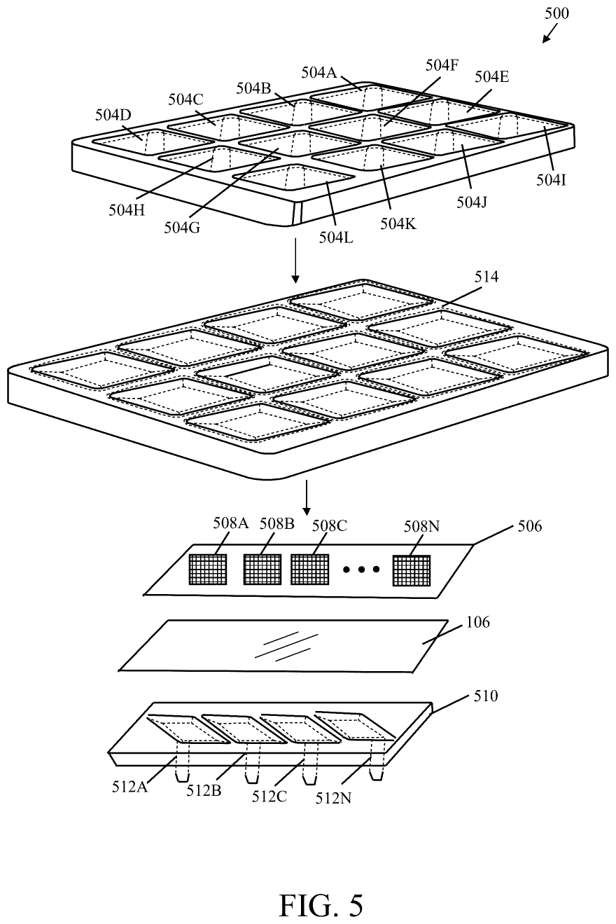

FIG. 5 is a diagram that illustrates attachment of a multi-layered peelable liner to a molded fiber structure, in accordance with an embodiment of the present disclosure. FIG. 5 is described in conjunction with FIGS. 1 to 4. With reference to FIG. 5, there is shown the diagram 500 that illustrates the attachment of the multi-layered peelable liner 106 to the molded fiber structure 102 that includes a lamination mold assembly 502, a heating assembly 506 having a plurality of heating boards (i.e., a first heating board 508A, a second heating board 508B, up to nth heating board 508N), and a vacuum suction assembly 510.

In an implementation scenario, the lamination mold assembly 502 refers to an assembly (or a platform) that includes a plurality of lamination molds configured to hold the molded fiber structures. Furthermore, the plurality of lamination molds is coupled together to form a uniform and stable platform in order to attach the multi-layered peelable liner 106 to the molded fiber structure 102. In an implementation, the plurality of lamination molds (i.e., a first lamination mold 504A, a second lamination mold 504B, a third lamination mold 504C, a fourth lamination mold 504D, a fifth lamination mold 504E, a sixth lamination mold 504F, a seventh lamination mold 504G, an eight lamination mold 504H, a ninth lamination mold 504I, a tenth lamination mold 504J, an eleventh lamination mold 504K, and a twelfth lamination mold 504L) is formed on the lamination mold assembly 502 in a grid pattern and each of the lamination mold from the plurality of lamination molds is matches the contours and dimensions of the molded fiber structure 102 thereby ensuring a precise alignment and consistent application of the multi-layered peelable liner 106. In operation, the plurality of molded fiber structures is initially placed at the plurality of plurality of lamination molds of the lamination mold assembly 502, such that the lamination mold assembly 502 becomes occupied lamination mold assembly 514.

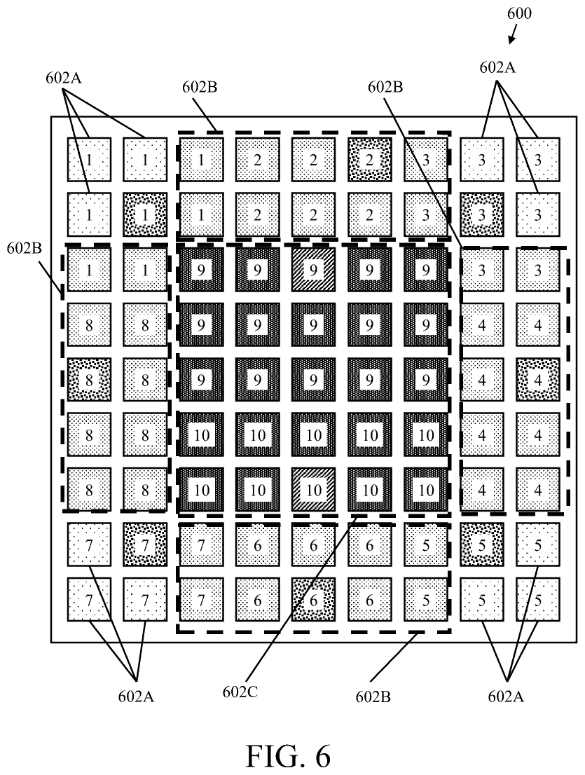

The heating assembly 506 refers to an assembly of the plurality of heating elements configured to provide controlled heat during the process of attaching the multi-layered peelable liner 106 to the molded fiber structure 102. Each of the plurality of heating boards of the heating assembly 506 may include a plurality of heating elements that may be arranged, for example, in a grid pattern (e.g., a 9×9 grid pattern). The plurality of heating elements may operate at precisely regulated temperatures that range between 600 degrees Celsius to 800 degrees Celsius to activate the adhesive properties of the different materials of the multi-layered peelable liner 106, such as polyethylene (PE), enabling a strong and consistent bond with the molded fiber structure 102. In an implementation, each heating board of the heating assembly 506 is configured to heat the multi-layered peelable liner 106 for a single molded fiber structure 102 where the plurality of heating elements is distributed across each heating board. Further, each heating board with the plurality of heating elements are distributed and operated with different temperatures in different zones like corner zones, a central zone, peripheral zones. Each zone may have different number of heating elements and may have different heating for fail-safe attachment of the multi-layered peelable liner 106 to the first surface of the molded fiber structure 102 which may have different contour and shape at different zones (further described for example in FIG. 6)

The vacuum suction assembly 510 refers to an assembly of plurality of vacuum suction elements (i.e., a first vacuum suction element, a second vacuum suction element 512B, a third vacuum suction element 512C, and up to nth vacuum suction element 512N). The vacuum suction assembly 510 is configured to create vacuum suction pressure between the heated multi-layered peelable liner 106 and the molded fiber structure 102 by applying vacuum suction pressure at a second surface of the molded fiber structure for a suction time of 5-20 seconds such that a suction of the heated multi-layered peelable liner 106 is caused through the plurality of perforations distributed across the molded fiber structure 102 to removably attach and conform the heated multi-layered peelable liner 106 on the first surface 104 of the molded fiber structure 102.

In operation, the plurality of molded fiber structures is placed at the plurality of plurality of lamination molds of the lamination mold assembly 502. Once the plurality of molded fiber structures is positioned within the occupied lamination molded assembly 514, and the heating assembly 506 is activated. Simultaneously, the required amount of the multi-layered peelable liner 106 is stretched from a film roll that contains the multi-layered peelable liner 106. The multi-layered peelable liner 106, which comprises polyethylene (PE) layers (40-65 weight percent), polyamide (PA) layers (10-25 weight percent), and an ethylene vinyl alcohol (EVOH) layer (5-25 weight percent), is drawn from a film roll using a movable jig. The movable jig ensures that the multi-layered peelable liner 106 is accurately aligned with the first surface 104 of the molded fiber structure 102, which corresponds to the product contact surface. Furthermore, the multi-layered peelable liner 106 is positioned below the heating assembly 506. The plurality of heating elements of the heating assembly 506 are maintained at a temperature range of 600 to 800 degrees Celsius to heat the multi-layered peelable liner 106. Moreover, the vacuum suction assembly 510 having the plurality of molded fiber structures apply a vacuum suction force that pulls the heated multi-layered peelable liner 106 tightly against the first surface 104 of the molded fiber structure 102 through a network of perforations distributed across the molded fiber structure 102. The vacuum suction is applied for a duration of 5 to 20 seconds while the heating continues simultaneously. The combination of heating and vacuum pressure eliminates air pockets and creates a smooth, secure bond between the multi-layered peelable liner 106 and the molded fiber structure 102. After completing the heating and vacuum suction cycle, the laminated molded fiber structure is moved further for the trimming of the multi-layered peelable liner 106 from the molded fiber structure 102.

Advantageously, the attachment of the multi-layered peelable liner 106 to the molded fiber structure 102 enhances the durability, moisture resistance, and compatibility of the MAP container 100 with various applications, such as food packaging for fresh produce, meat, poultry, and seafood. The heating assembly 506, with the plurality of heating elements operating at a precisely controlled temperature range of 600 to 800 degrees Celsius, activates the adhesive properties of the multi-layered peelable liner 106. The vacuum suction assembly 510 ensures a smooth and conforming attachment of the multi-layered peelable liner 106 to the molded fiber structure 102. By applying vacuum suction pressure for a duration of 5 to 20 seconds, the process of the attachment of the multi-layered peelable liner 106 to the molded fiber structure 102 eliminates air pockets and achieves a flawless application of the multi-layered peelable liner 106 on the molded fiber structure 102. Additionally, the trimming operation removes any excess portions of the multi-layered peelable liner 106, ensuring a clean and precise finish of the MAP container 100.

FIG. 6 is a diagram that illustrates a plurality of heating elements of the heating board used in the attachment of a multi-layered peelable liner to a molded fiber structure, in accordance with an embodiment of the present disclosure. FIG. 6 is described in conjunction with the FIGS. 1 to 5. With reference to FIG. 6, there is shown a diagram 600 of the heating board (e.g., the first heating board 508A) that comprises the plurality of heating element arranged, for example, in a 9×9 grid pattern.

In an exemplary scenario, the heating board (e.g., the first heating board 508A) comprises the plurality of heating elements arranged in different groups, wherein the temperature of each heating element of the plurality of heating elements is adjusted independently, such that different areas of the multi-layered peelable liner 106 are heated with different temperatures. The first group of plurality of heating elements 602A are placed along the peripheral region of the heating board and provide heat to the edges of the multi-layered peelable liner 106. The second group of heating elements 602B are placed in the intermediate region of the heating board, surrounding the central portion of the heating board, and provides heat to the areas closer to the middle of the multi-layered peelable liner 106. The third group of plurality of heating elements 602C are placed at the central region of the heating board, directly beneath the core portion of the multi-layered peelable liner 106 and are configured to apply intense and concentrated heat to ensure that the central portion of the multi-layered peelable liner 106 adheres firmly to the first surface 104 of the molded fiber structure 102. In an example, the first group of plurality of heating elements 602A are configured to maintain a temperature that ranges from 600° C. to 650° C. to prevent overheating of the edges of the multi-layered peelable liner 106, while maintaining sufficient heat for proper adhesion. Similarly, the second group of plurality of heating elements 602A are configured to maintain a temperature that ranges from 650° C. to 700° C. and the first group of plurality of heating elements 602A are configured to maintain to maintain the temperature that ranges from 700° C. to 800° C. that ensures a precise conforming of the multi-layered peelable liner 106 to the first surface 104 of the molded fiber structure 102 without creating weak points or compromising the seal integrity of the multi-layered peelable liner 106. Furthermore, there exist some individual heating elements that are described with cri-cross pattern (as depicted in in FIG. 4), which are configured to apply a different heating temperature to specific areas of the multi-layered peelable liner 106. For example, an individual heating element is configured to provide a high temperature of 750° C. to a specific area of the peelable liner 106 that is going to be conformed to a raised part of the molded fiber structure, such that the heat softens multi-layered peelable liner 106 adequately to conform to the contours of the raised part without causing wrinkling, tearing, or uneven adhesion. In another example, another heating element is configured to provide a moderate temperature of 650° C. to an edge of the multi-layered peelable liner 106, ensuring precise adhesion of the multi-layered peelable liner 106 along a peripheral part of the molded fiber structure 102 without overheating or causing the multi-layered peelable liner 106 to become brittle at the peripheral part of the molded fiber structure 102. Advantageously, the independent temperature control of each of the heating elements of the plurality of heating element enables a precise heat management during the attachment process of the multi-layered peelable liner 106 to the molded fiber structure 102 while preventing any damage to the material of the multi-layered peelable liner 106 of the MAP container 100.

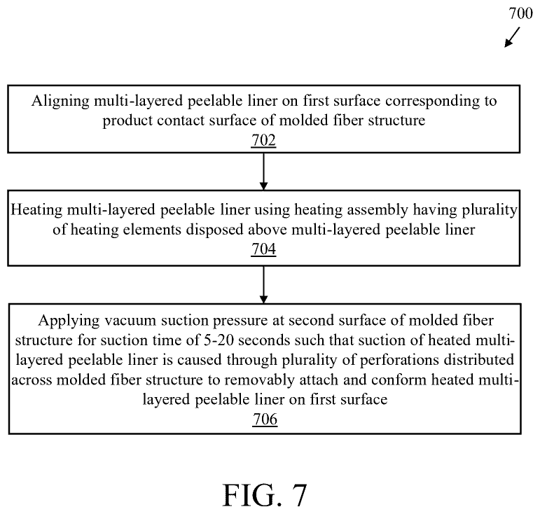

FIG. 7 is a flowchart that illustrates a method for removably attaching a multi-layered peelable liner to a molded fiber structure, in accordance with an embodiment of the present disclosure. FIG. 7 is described in conjunction with the FIGS. 1 to 6. With reference to FIG. 7, there is shown the method 700 for removably attaching the multi-layered peelable liner 106 to the molded fiber structure 102. The method 700 includes steps 702 to 226.

There is provided the method 700 for removably attaching the multi-layered peelable liner 106 to the molded fiber structure 102. The method 700 provides a systematic approach for removably attaching the multi-layered peelable liner 106 to the molded fiber structure 102, comprising specific steps of aligning, heating, and vacuum-based attachment. The method 700 addresses the challenge of providing uniform attachment between dissimilar materials, such as a polymer-based multilayer film and a porous fiber structure while maintaining the integrity of both components. The method 700 achieves zero pinhole defects as verified through oil and ethyl alcohol tests, maintains consistent adhesion strength between 1-5 Newtons per 15 millimeters across the entire surface of the multi-layered peelable liner 106, and ensures uniform barrier properties with oxygen transmission rates below 0.1 cc/m²/day.

At step 702, the method includes aligning the multi-layered peelable liner 106 on the first surface 104 corresponding to product contact surface of the molded fiber structure 102. The multi-layered peelable liner comprises the plurality of PE layers in the range of 40-65 wt. %, the plurality of polyamide PA layers in the range of 10 to 25 wt. %, and the EVOH layer in the range of 5-25 wt. %. The alignment of the multi-layered peelable liner 106 on the first surface 104 corresponding to product contact surface of the molded fiber structure 102 is achieved through the lamination mold assembly 502. The molded fiber structure 102 is precisely positioned within the plurality of lamination molds of the lamination mold assembly 502 using alignment pins and stops, ensuring repeatable placement of the molded fiber structure relative to the multi-layered peelable liner 106. The controlled alignment of the multi-layered peelable liner 106 on the first surface 104 corresponding to product contact surface of the molded fiber structure 102 ensures consistent overlap between the multi-layered peelable liner 106 and the molded fiber structure 102 that optimizes the subsequent application of vacuum suction pressure, ensuring uniform attachment across the entire surface of the multi-layered peelable liner 106.

At step 704, the method 700 includes heating the multi-layered peelable liner 106 using the heating assembly 506 having a plurality of heating elements disposed above the multi-layered peelable liner 106. The plurality of heating elements is maintained at a temperature in the range of 600 degrees Celsius to 800 degrees Celsius. The heating assembly 506 is configured to provide controlled and uniform heat to the multi-layered peelable liner 106. The heating assembly 506 operates within the temperature range of 600° C. to 800° C. to ensure proper bonding of the multi-layered peelable liner 106 to the molded fiber structure 102 without compromising the structural integrity of the multi-layered peelable liner 106. Moreover, the heating of the multi-layered peelable liner 106 is synchronized with the vacuum suction assembly 510, which applies suction pressure through perforations in the molded fiber structure 102 to pull the heated multi-layered peelable liner 106 tightly against the first surface 104 of the molded fiber structure 102. The combination of heat and vacuum section pressure ensures that the multi-layered peelable liner 106 conforms to the contours of the molded fiber structure 102, creating a smooth and secure bond. The heating assembly 506, with the plurality of heating elements, allows for precise temperature control and differential heating, which can be adjusted to accommodate variations in the shape, size, or material properties of the molded fiber structure 102.

In accordance with an embodiment, the method 700 further comprises setting a plurality of different temperatures for different sections the heating assembly 506 for differential heating across the multi-layered peelable liner 106 to allow conformation of the multi-layered peelable liner 106 in accordance with a structure, a shape, a size of each molded fiber structure 102. By virtue of setting a plurality of different temperatures for different sections of the heating assembly 506 enables the application of differential heating across the multi-layered peelable liner 106. During the lamination process, the multi-layered peelable liner 106 is positioned above the molded fiber structure 102, and the heating assembly 506 is activated. The temperatures of the plurality of heating elements are adjusted based on the structure, shape, and size of the molded fiber structure 102. For example, areas of the molded fiber structure 102 with thicker or more complex contours may require higher temperatures to ensure proper adhesion, while flatter or thinner areas may require lower temperatures to prevent overheating. The differential heating process ensures that the multi-layered peelable liner 106 conforms tightly to the contours of the molded fiber structure 102. In an implementation, the precise temperature control across the plurality of heating elements in the heating assembly 506 is achieved through a combination of sensors, controllers, and pre-programmed settings that allow the heating assembly 506 to deliver targeted heat to specific sections of the multi-layered peelable liner 106. The heating process is synchronized with the application of vacuum suction pressure, which pulls the heated liner against the molded fiber structure 102, ensuring a smooth and secure bond. Thus, the differential heating across the multi-layered peelable liner 106 ensures precise conformation to the contours and dimensions of the molded fiber structure 102, regardless of its shape, size, or complexity.

In accordance with an embodiment, the heating duration of the multi-layered peelable liner 106 is the range of 6-12 seconds. During the heating duration of 6-12 seconds, the heat activates the adhesive properties of the PE layers in the multi-layered peelable liner 106, allowing the multi-layered peelable liner 106 to bond securely to the first surface 104 of the molded fiber structure 102. In an example, the heating duration of the heating the multi-layered peelable liner 106 is 6 seconds. In another example, the heating duration of the heating the multi-layered peelable liner 106 is 12 seconds. In yet another example, heating duration of the heating of the multi-layered peelable liner 106 is 9 seconds. In an implementation, the heating duration is monitored and controlled using sensors and timers integrated into the heating assembly 506, ensuring precise and consistent application of heat across multiple molded fiber structures. Thus, the specified heating duration of 6-12 seconds ensures that the multi-layered peelable liner 106 is heated for an optimal amount of time to activate the adhesive properties without causing thermal degradation or damage to the multi-layered peelable liner 106 or the molded fiber structure 102.

At step 706, the method 700 includes applying the vacuum suction pressure at the second surface of the molded fiber structure 102 for a suction time of 5-20 seconds such that the suction of the heated multi-layered peelable liner 106 is caused through the plurality of perforations distributed across the molded fiber structure 102 to removably attach and conform the heated multi-layered peelable liner 106 on the first surface 104. The heating continues during the application of the vacuum suction pressure until the heated multi-layered peelable liner 106 conforms on the first surface 104. The vacuum suction pressure is applied through the vacuum suction assembly 510, which interacts with the plurality of perforations distributed across the molded fiber structure 102. The application of the vacuum suction pressure causes the heated multi-layered peelable liner 106 to be pulled tightly against the first surface of the molded fiber structure 102, which corresponds to the product contact surface. The vacuum suction ensures that the heated multi-layered peelable liner 106 conforms to the contours and dimensions of the molded fiber structure 102, providing a secure and uniform attachment. In an example, the vacuum suction pressure at the second surface of the molded fiber structure 102 is applied for a suction time of 5 seconds. In another example, the vacuum suction pressure at the second surface of the molded fiber structure 102 is applied for a suction time of 20 seconds. In yet another example, the vacuum suction pressure at the second surface of the molded fiber structure 102 is applied for a suction time of 15 seconds. The suction time of 5-20 seconds is calibrated to achieve optimal adhesion without causing damage to the multi-layered peelable liner 106 or the molded fiber structure 102.

Advantageously, the method 700 for removably attaching the multi-layered peelable liner 106 to the molded fiber structure 102 is used to provide a uniform attachment between dissimilar materials, such as a polymer-based multilayer film and a porous fiber structure. The method 700 ensures precise alignment, controlled heating, and vacuum-based attachment, resulting in a secure and uniform bond between the multi-layered peelable liner 106 and the molded fiber structure 102. The oxygen transmission rate (OTR) of the MAP container is maintained below 1 cubic centimeters per square meter per day (cc/m²/day), while the water vapor transmission rate (WVTR) and carbon dioxide transmission rate (CO₂TR) are kept below 5 grams per square meter per day across a wide temperature range of 0° C. to 40° C. and relative humidity levels of 10% to 90%, ensuring extended shelf life and preservation of the food product 406. The method 700 also ensures that the multi-layered peelable liner 106 conforms precisely to the contours and dimensions of the molded fiber structure 102, regardless of the shape, size, or complexity of the molded fiber structure 102.

### Experimental Part

### 1. Preparation of the Molded Fiber Structure

Example 1: Initially, for experimental setup, 5 grams of slurry made up of agro-waste pulp (specifically, sugarcane bagasse) is mixed with 100 milliliters (ml) of water in the pulping machine at an ambient temperature of 25° C. It is to be understood by one of ordinary skill in the art that the amount of slurry can be increased to kilograms and proportionally other items like water may be added in the pulping machine in an industrial setup using the above information, without limiting the scope of the disclosure. For example, for industrial setup, 500 kilograms of slurry made up of agro waste (specifically, sugarcane bagasse) mixed 10,000 liters of water in the pulping machine at ambient temperature of 25° C. The mixing is continued for 30 minutes to achieve uniform consistency, resulting in a homogeneous pulp suitable for molding. Further, the homogeneous pulp is fed into a pulp molding machine equipped with a mold cavity that determines the shape, size, and structural features of the resulting molded fiber. The resulting molded fiber undergoes a drying process at temperature of 300° C. for 60 seconds to achieve optimal strength and dimensional stability. After drying, the dried molded fiber is precision-trimmed to obtain the molded fiber structure 102.

Example 2: Initially, for experimental setup, 5 grams of slurry made up of agro-waste pulp (specifically, sugarcane bagasse) is mixed with 100 milliliters (ml) of water in the pulping machine at ambient temperature of 25° C. The mixing is continued for 30 minutes to achieve uniform consistency, resulting in a homogeneous pulp suitable for molding. Further, the homogeneous pulp is fed into a pulp molding machine equipped with a mold cavity that determines the shape, size, and structural features of the resulting molded fiber. The resulting molded fiber undergoes a drying process at temperature of 250° C. for 80 seconds to achieve optimal strength and dimensional stability. After drying, the dried molded fiber is precision-trimmed to obtain the molded fiber structure 102.

Example 3: Initially, for experimental setup, 5 grams of slurry made up of agro-waste pulp (specifically, sugarcane bagasse) is mixed with 100 milliliters (ml) of water in the pulping machine at ambient temperature of 25° C. The mixing is continued for 30 minutes to achieve uniform consistency, resulting in a homogeneous pulp suitable for molding. Further, the homogeneous pulp is fed into a pulp molding machine equipped with a mold cavity that determines the shape, size, and structural features of the resulting molded fiber. The resulting molded fiber undergoes a drying process at temperature of 150° C. for 120 seconds to achieve optimal strength and dimensional stability. After drying, the dried molded fiber is precision-trimmed to obtain the molded fiber structure. It is to be understood by one of ordinary skill in the art that the amount of slurry can be increased to kilograms and proportionally other items like water may be added in the pulping machine in an industrial setup using the above information, without limiting the scope of the disclosure in the above examples.

### 2. Preparation of the Multi-Layered Peelable Liner

Example 1: Initially, a first PE layer that acts as the base layer with a thickness of approximately 9 micrometers (μm) is taken. A second PE layer, also with a thickness of 9 μm, is extruded onto the first PE layer. Further, a tie layer, composed of an adhesive polymer, is applied to bond the PE layers to the subsequent PA layer. Then, a first PA layer with a thickness of 10 μm is extruded onto the tie layer. Furthermore, an EVOH layer with a thickness of 5 μm is extruded onto the first PA layer. Then, a second tie layer is extruded onto the EVOH layer. Moreover, a third PE layer with a thickness of 9 μm is extruded onto the second tie layer. Finally, a fourth PE layer with a thickness of 9 μm is extruded onto the third PE layer as the outermost layer to make the multi-layered peelable liner 106. The formed multi-layered peelable liner 106 is composed of the PE at 40 wt. %, the PA at 10 wt. %, the EVOH at 5 wt. %, and the tie at 5 wt. % (as described in Table 2).

Example 2: Initially, a first PE layer that acts as the base layer with a thickness of approximately 11 micrometers (μm) is taken. A second PE layer, also with a thickness of 11 μm, is extruded onto the first PE layer. Further, a tie layer, composed of an adhesive polymer, is applied to bond the PE layers to the subsequent PA layer. Then, a first PA layer with a thickness of 12 μm is extruded onto the tie layer. Furthermore, an EVOH layer with a thickness of 15 μm is extruded onto the first PA layer. Moreover, a second PA layer with a thickness of 12 μm is extruded onto the EVOH layer. Then, a second tie layer is extruded onto the second PA layer. Furthermore, a third PE layer with a thickness of 11 μm is formed on the second tie layer. Finally, a fourth PE layer with a thickness of 11 μm is extruded onto the third PE layer as the outermost layer to make the multi-layered peelable liner 106. The formed multi-layered peelable liner is composed of the PE at 50 wt. %, the PA at 15 wt. %, the EVOH at 10 wt. %, and the tie at 10 wt. % (as described in the Table 2). However, the multi-layered peelable liner fails the different tests (as described in the Table 2).

Example 3: Initially, a first PE layer that acts as the base layer with a thickness of approximately 24 micrometers (μm) is taken. A second PE layer, also with a thickness of 24 μm, is extruded onto the first PE layer. Further, a third PE layer, also with a thickness of 24 μm is extruded onto the second PE layer. Then, a fourth PE layer, also with a thickness of 24 μm is extruded onto the third PE layer. Furthermore, an EVOH layer of a thickness of 22 μ is extruded onto the fourth PE layer. Then, a fifth PE layer with a thickness of 24 μm, is extruded onto the EVOH layer. Moreover, the sixth PE layer, also with a thickness of 24 m, is extruded onto the fifth PE layer. Then, the seventh PE layer, also with a thickness of 24 μm is extruded onto the sixth PE layer. Finally, the eighth PE layer, also with a thickness of 24 m, is extruded onto the seventh PE layer to make the multi-layered peelable liner 106. The formed multi-layered peelable liner is composed of the PE at 85 wt. % and the EVOH at 15 wt. %. However, the multi-layered peelable liner fails the different tests (as described in the Table 2).

### 3. Preparation of the MAP Container

Example 1: Initially, a molded fiber structure 102 is placed on a lamination mold within a lamination mold assembly 502, which is then positioned on a vacuum suction assembly 510. An example of the system is described, for example, in FIG. 5. A multi-layered peelable liner is aligned on the first surface of the molded fiber structure. A heating assembly 506, positioned above the multi-layered peelable liner 106 and equipped with a plurality of heating boards, is maintained at a temperature of approximately 600° C., which causes the multi-layered peelable liner 106 to heat and soften within 12 seconds. Simultaneously, a plurality of vacuum suction elements in the vacuum suction assembly 510 creates suction pressure through the perforations in the molded fiber structure 102 for 20 seconds, which causes the heated multi-layered peelable liner 106 to conform tightly to the first surface 104 of the molded fiber structure 102, ensuring proper adhesion and uniform coverage, which results in the preparation of the MAP container 100. (as described in Table 4)

Example 2: Initially, a molded fiber structure 102 is placed on a lamination mold within a lamination mold assembly 502, which is then positioned on a vacuum suction assembly 510. A multi-layered peelable liner is aligned on the first surface 104 of the molded fiber structure 102. A heating assembly 506, positioned above the multi-layered peelable liner 106 and equipped with a plurality of heating boards, is maintained at a temperature of approximately 800° C., which causes the multi-layered peelable liner 106 to heat and soften within 6 seconds. Simultaneously, a plurality of vacuum suction elements in the vacuum suction assembly creates suction pressure through the perforations in the molded fiber structure 102 for 5 seconds, which causes the heated multi-layered peelable liner to conform tightly to the first surface of the molded fiber structure 102, ensuring proper adhesion and uniform coverage, which results in the preparation of the MAP container 100. (as described in the Table 4)

Example 3: Initially, a molded fiber structure is placed on a lamination mold within a lamination mold assembly 502, which is then positioned on a vacuum suction assembly 510. A multi-layered peelable liner 106 is aligned on the first surface 104 of the molded fiber structure 102. A heating assembly 506, positioned above the multi-layered peelable liner 106 and equipped with a plurality of heating boards, is maintained at a temperature of approximately 700° C., which causes the multi-layered peelable liner 106 to heat and soften within 8 seconds. Simultaneously, a plurality of vacuum suction elements in the vacuum suction assembly creates suction pressure through the perforations in the molded fiber structure for 12 seconds, which causes the heated multi-layered peelable liner to conform tightly to the first surface of the molded fiber structure, ensuring proper adhesion and uniform coverage, which results in the preparation of the MAP container (as described in the Table 4).

The MAP container comprising the molded fiber structure and the multi-layered peelable liner is further tested for a first pinhole test (with 95% ethyl alcohol), a second pinhole test with hot oil, a vacuum leakage test and shelf life study. In the first pinhole test, the MAP container is inspected for pinholes or breaches that could compromise the barrier properties of the multi-layered peelable liner. The second pinhole test tests the resistance of the multi-layered peelable liner to penetration and degradation when exposed to high-temperature environments. Furthermore, during the vacuum leakage test, the multi-layered peelable liner is subjected to vacuum pressure of up to 15 inches of mercury (inHG) while the multi-layered peelable liner is submerged in water. Additionally, the shelf life study evaluates the long-term reliability of the multi-layered peelable liner. The multi-layered peelable liner is subjected to environmental conditions such as temperature, humidity, and exposure to oxygen over an extended time period, typically from 6 months to 12 months. Table 2 represents the result of the different tests (i.e., the first pinhole test (with 95% ethyl alcohol), the second pinhole test with hot oil, the vacuum leakage test, and the shelf life study) of the multi-layered peelable liners with different layer compositions.

### Testing for Pinholes, Vacuum Leakage and Shelf Life

TABLE 2

| | Composition | | | | | | | | | | | |
|---|---|---|---|---|---|---|---|---|---|---|---|---|
| | of the | | | | | | | | | | | |
| | different | | | | | H_{T} | V_{T} | Adhesion | Different Tests | | | |
| S. No | layers | A | B | C | D | (s) | (s) | Check | T1 | T2 | T3 | T4 |
| 1 | a first PE layer- | 80 | 2 | 4.5 | 675 | 8 | 5 | Pass | Fail | Fail | Fail | Fail |
| | a second PE layer- | | | | | | | | | | | |
| | a third PE layer- | | | | | | | | | | | |
| | a fourth PE layer- | | | | | | | | | | | |
| | an EVOH layer- | | | | | | | | | | | |
| | a fifth PE layer- | | | | | | | | | | | |
| | a sixth PE layer- | | | | | | | | | | | |
| | a seventh PE- | | | | | | | | | | | |
| | an eight PE layer | | | | | | | | | | | |
| | (EVOH: 15%, PE: 83%, | | | | | | | | | | | |
| | Tie: 2%) | | | | | | | | | | | |
| 2 | a first PE layer- | 125 | 1.3 | 3 | 675 | 6 | 8 | Pass | Pass | Pass | Pass | Pass |
| | a second PE layer- | | | | | | | | | | | |
| | a first Tie layer- | | | | | | | | | | | |
| | a first PA layer- | | | | | | | | | | | |
| | a first EVOH layer- | | | | | | | | | | | |
| | a second PA layer- | | | | | | | | | | | |
| | a second Tie layer- | | | | | | | | | | | |
| | a third PE layer- | | | | | | | | | | | |
| | a fourth PE layer | | | | | | | | | | | |
| | (PA: 20%, EVOH: 15%, | | | | | | | | | | | |
| | PE: 63%, Tie: 2%) | | | | | | | | | | | |
| 3 | a first PE layer- | 150 | 1 | 2 | 700 | 9 | 8 | Pass | Fail | Fail | Fail | Fail |
| | a second PE layer- | | | | | | | | | | | |
| | a first Tie layer- | | | | | | | | | | | |
| | a first PA layer- | | | | | | | | | | | |
| | a first EVOH layer- | | | | | | | | | | | |
| | a second PA layer- | | | | | | | | | | | |
| | a second Tie layer- | | | | | | | | | | | |
| | a third PE layer- | | | | | | | | | | | |
| | a second PE layer | | | | | | | | | | | |
| | (PA: 20%, EVOH: 15%, | | | | | | | | | | | |
| | PE: 63%, Tie: 2%) | | | | | | | | | | | |
| 4 | a first PE layer- | 150 | 1 | 2 | 675 | 10 | 8 | Pass | Pass | Pass | Pass | Pass |
| | a second PE layer- | | | | | | | | | | | |
| | a first Tie layer- | | | | | | | | | | | |
| | a first PA layer - | | | | | | | | | | | |
| | first EVOH layer- | | | | | | | | | | | |
| | a second PA layer- | | | | | | | | | | | |
| | a second Tie layer- | | | | | | | | | | | |
| | a third PE layer- | | | | | | | | | | | |
| | a fourth PE layer | | | | | | | | | | | |
| | (PA: 20%, EVOH: 15%, | | | | | | | | | | | |
| | PE: 863%, Tie: 2%) | | | | | | | | | | | |
| 5 | A first PE layer- | 150 | 1 | 2 | 675 | 11 | 8 | Pass | Fail | Fail | Fail | Fail |
| | a second PE layer- | | | | | | | | | | | |
| | a first Tie layer- | | | | | | | | | | | |
| | a first PA layer- | | | | | | | | | | | |
| | an EVOH layer- | | | | | | | | | | | |
| | a second PA layer- | | | | | | | | | | | |
| | a second Tie layer- | | | | | | | | | | | |
| | a third PE layer | | | | | | | | | | | |
| | a fourth PE layer | | | | | | | | | | | |
| | (PA: 20%, EVOH: 15%, | | | | | | | | | | | |
| | PE: 63%, Tie: 2%) | | | | | | | | | | | |

The Table 2 represent multi-layered peelable liners with different compositions of layers having a total thickness (i.e., A) in micrometers (μm), water vapor transmission rate (i.e., B) measured in gm/m²/day as per ASTM D1249, oxygen transmission rate (i.e., C) measured in cc/m²/day as per ASTM D3985. Furthermore, the sixth column (i.e., D) represents the temperature of the plurality of heating elements in ° C. Moreover, the seventh column (denoted by H_{T}) represents heating time or (heating duration) of the multi-layered peelable liner and the eight column represents vacuum time (i.e., the duration of time for which the vacuum suction assembly 512 applies the vacuum suction pressure), each measured in seconds. The night column represents the adhesion check of the multi-layered peelable liner 106. Moreover, the Table 2 represents the result of the different tests (i.e., the first pinhole test (with 95% ethyl alcohol) denoted by T1, the second pinhole test with hot oil denoted by T2, the vacuum leakage test denoted by T3, and the test for shelf life study denoted by T4) of the multi-layered peelable liners with different layer compositions.

Furthermore, the Table 2 shows that the multi-layered peelable liner with a thickness of 150 μm, having WVTR of 1 gm/m²/day and OTR of 2 cc/m²/day, heated at a temperature 675° C. for 10 seconds and vacuum suctioned for 8 seconds with the first PE layer-the second PE layer-the first Tie layer-the first PA layer-the first EVOH layer-the second PA layer-the second Tie layer-the third PE layer-the fourth PE layer, the composition of the PA at 20 wt. %, the EVOH at 15 wt. %, the PE at 63 wt. %, and the Tie at 2 wt. % passes the first pinhole test (with 95% ethyl alcohol), the second pinhole test with hot oil, the vacuum leakage test, and the shelf life study, while other multi-layered peelable liner fails one or more tests.

Testing Oxygen transmission rates (OTR) and Water vapor transmission rates (WVTR): The MAP container is tested for oxygen transmission rates (OTR) and water vapor transmission rates (WVTR) to ensure the suitability of the MAP container for Modified Atmosphere Packaging (MAP) applications. Table 3 represents WVTR and OTR readings for the multi-layered peelable liner with different composition of different layers (i.e., the plurality of PE layers, the plurality of PA layer, the EVOH layers, the plurality of Tie layers). The WVTR readings are taken at American Society for Testing and Materials (ASTM), specifically, ASTM D1249, which is a method used to measure the rate at which water vapor passes through a material, expressed in grams per square meter per day (gm/m²/day). The OTR readings are taken at ATSMD3986, which is a method used to measure the rate at which oxygen passes through a material, expressed in cubic centimeters per square meter per day (cc/m²/day).

Testing for Adhesion and Peel-off (Peelability): Based on this test, it was found that the adhesion strength and peelability of the multi-layered peelable liner depends on following factors: temperature of the heating element used to heat the multi-layered peelable liner, duration for which the liner is heated and the duration for which the vacuum suction pressure in applied to the multi-layered peelable liner. Ideally, the adhesion strength of the multi-layered peelable liner should be in the range of 1 to 5 N/15 mm and the multi-layered peelable liner should peel off cleanly without leaving residue or damaging the molded fiber structure. Table 2 below represents the results of the Adhesion and Peel-off Test for different compositions of the multi-layered peelable liner under varying process parameters, including the temperature of the heating element, heating time, and vacuum time.

As described in Table 2, it was found that the multi-layered peelable liner, having a first PE layer, a second PE layer, a first Tie layer, a first PA layer, a first EVOH layer, a second PA layer, a second Tie layer, a third PE layer, and a fourth PE layer, passes the Adhesion and Peel-off Test when heated at 675° C. for 6 seconds and subjected to vacuum suction pressure for 8 seconds. The same multi-layered peelable liner also passes the Adhesion and Peel-off Test when heated at 675° C. for 10 seconds and subjected to vacuum suction pressure for 8 seconds. However, the multi-layered peelable liner fails the Adhesion and Peel-off Test when heated for less than 6 seconds or more than 12 seconds.

TABLE 3

| | | | WVTR | OTR |
|---|---|---|---|---|
| | Composition of the | Thickness | (ASTM D1249 | (ASTM D3985 |
| S. No | different layers | (μ) | gm/m2/day) | cc/m2/day) |
| 1 | a first PE layer- a second PE layer- | 80 | 2 | 4.5 |
| | a third PE layer- a fourth PE layer- | | | |
| | an EVOH layer- a fifth PE layer- | | | |
| | a sixth PE layer- a seventh PE- | | | |
| | an eight PE layer | | | |
| | (EVOH: 15%, PE: 83%, Tie: 2%) | | | |
| 2 | A first PE layer- a second PE layer- | 125 | 1.3 | 3 |
| | a first Tie layer- a first PA layer- | | | |
| | a first EVOH layer- a second PA layer- | | | |
| | a second Tie layer- a third PE layer- | | | |
| | a fourth PE layer | | | |
| | (PA: 20%, EVOH: 15%, | | | |
| | PE: 63%, Tie: 2%) | | | |
| 3 | a first PE layer- a second PE layer- | 150 | 1 | 2 |
| | a first Tie layer- a first PA layer- | | | |
| | a first EVOH layer- a second PA layer- | | | |
| | a second Tie layer- a third PE layer- | | | |
| | a second PE layer | | | |
| | (PA: 20%, EVOH: 15%, | | | |
| | PE: 63%, Tie: 2%) | | | |
| 4 | a first PE layer- a second PE layer- | 150 | 1 | 2 |
| | a first Tie layer-a first PA layer - | | | |
| | first EVOH layer-a second PA layer- | | | |
| | a second Tie layer- a third PE layer- | | | |
| | a fourth PE layer | | | |
| | (PA: 20%, EVOH: 15%, | | | |
| | PE: 63%, Tie: 2%) | | | |
| 5 | A first PE layer- a second PE layer- | 150 | 1 | 2 |
| | a first Tie layer- a first PA layer- | | | |
| | an EVOH layer- a second PA layer- | | | |
| | a second Tie layer- a third PE layer | | | |
| | a fourth PE layer | | | |
| | (PA: 20%, EVOH: 15%, | | | |
| | PE: 63%, Tie: 2%) | | | |

As described in Table 3, it was found that the multi-layered peelable liner with an OTR less than or equal to 5 cc/m²/day and a WVTR less than or equal to 5 gm/m²/day passes both the OTR and WVTR tests. Evidently, the multi-layered peelable liner comprising a first PE layer, a second PE layer, a first Tie layer, a first PA layer, an EVOH layer, a second PA layer, a second Tie layer, a third PE layer, and a fourth PE layer, which has an OTR of 1 cc/m²/day and a WVTR of 2 gm/m²/day, passes both the OTR and WVTR tests. Therefore, this configuration can be used for making the multi-layered peelable liner.

Modifications to embodiments of the present disclosure described in the foregoing are possible without departing from the scope of the present disclosure as defined by the accompanying claims. Expressions such as “including,” “comprising,” “incorporating,” “have,” “is” used to describe, and claim the present disclosure are intended to be construed in a non-exclusive manner, namely allowing for items, components or elements not explicitly described also to be present. Reference to the singular is also to be construed to relate to the plural. The word “exemplary” is used herein to mean “serving as an example, instance, or illustration.” Any embodiment described as “exemplary” is not necessarily to be construed as preferred or advantageous over other embodiments or to exclude the incorporation of features from other embodiments. The word “optionally” is used herein to mean “is provided in some embodiments and not provided in other embodiments.” It is appreciated that certain features of the present disclosure, which are, for clarity, described in the context of separate embodiments, may also be provided in combination in a single embodiment. Conversely, various features of the invention, which are, for brevity, described in the context of a single embodiment, may also be provided separately or in any suitable combination or as suitable in any other described embodiment of the disclosure.

1. A modified atmosphere packaging (MAP) container, comprising:
a molded fiber structure comprises a set of perforations distributed across the molded fiber structure;
a multi-layered peelable liner removably attached to a first surface corresponding to a product contact surface of the molded fiber structure,
wherein the multi-layered peelable liner comprises:
a plurality of polyethylene (PE) layers in a range of 40-65 weight percent (wt. %);
a plurality of polyamide (PA) layers in a range of 10 to 25 wt. %; and
an ethylene vinyl alcohol (EVOH) layer in a range of 5-25 wt. %.

2. The MAP container according to claim 1, wherein the multi-layered peelable liner further comprises a plurality of intermediate tie layers in the range of 5-10 weight percent (wt. %).

3. The MAP container according to claim 2, wherein each of the plurality of intermediate tie layers is disposed between one PE layer of the plurality of PE layers and one PA layer of the plurality of PA layers.

4. The MAP container according to claim 1, wherein the MAP container further comprises a lidding film configured to seal the MAP container.

5. The MAP container according to claim 1, wherein the multi-layered peelable liner is a nine-layered peelable structure in which the plurality of PE layers, the plurality of PA layers, and the EVOH layer are disposed in a sequence of: a first PE layer-a second PE layer-a first intermediate Tie layer-a first PA layer-the EVOH layer-a second PA layer-a second intermediate Tie layer-a third PE layer-a fourth PE layer.

6. The MAP container according to claim 4, wherein the multi-layered peelable liner comprises polyamide (PA) in 20 weight percent (wt. %), polyethylene (PE) in 63 wt. %, ethylene vinyl alcohol (EVOH) in 15 wt. %, and Tie layers in 2 wt. %.

7. The MAP container according to claim 5, wherein the multi-layered peelable liner is in range of 60-160 micrometers.

8. The MAP container according to claim 5, wherein a thickness of the multi-layered peelable liner is in a range of 120-180 micrometers.

9. The MAP container according to claim 1, wherein the MAP container further comprising a moisture absorbent pad disposed on the first surface of the molded fiber structure.

10. The MAP container according to claim 1, wherein the multi-layered peelable liner has an adhesion strength ranging from 1 to 5 Newtons per 15 millimeters when removably attached to the first surface of the molded fiber structure.

11. The MAP container according to claim 1, wherein, when a food product is stored in the MAP container, a combination of the multi-layered peelable liner and a lidding film that seals the MAP container acts as an oxygen barrier and modifies internal atmosphere of the MAP container such that an oxygen transmission rate (OTR) of the MAP container is less than 1 cubic centimeters per square meter per day (cc/m²/day) at a temperature range of 0° C. to 40° C. and a relative humidity range of 10% to 90%.

12. The MAP container according to claim 1, wherein, when a food product is stored in the MAP container, a combination of the multi-layered peelable liner and a lidding film that seals the MAP container acts as a water vapor barrier and modifies internal atmosphere of the MAP container such that a water vapor transmission rate (WVTR) of the MAP container is less than 5 grams per square meter per day at a temperature range of 0° C. to 40° C. and a relative humidity range of 10% to 90%.

13. The MAP container according to claim 1, wherein, when a food product is stored in the MAP container, a combination of the multi-layered peelable liner and a lidding film that seals the MAP container acts as a carbon dioxide barrier and modifies internal atmosphere of the MAP container such that a carbon dioxide transmission rate (CO₂TR) of the MAP container is less than 5 grams per square meter per day at a temperature range of 0° C. to 40° C. and a relative humidity range of 10% to 90%.

14. The MAP container according to claim 1, wherein the molded fiber structure is made from a material that is one of: agro-waste pulp, recycled paper, cardboard, plant-based biodegradable fibers, wood-based biodegradable fibers, or one or more combinations thereof.

15. The MAP container according to claim 1, wherein each of the plurality of polyethylene (PE) layers has a thickness in a range of 9-24 micrometers (μm).

16. The MAP container according to claim 1, wherein each of the plurality of polyamide (PA) layers has a thickness in a range of 10-15 micrometers (μm).

17. The MAP container according to claim 1, wherein the ethylene vinyl alcohol (EVOH) layer has a thickness in a range of 12-22 micrometers (μm).

18. A method for removably attaching a multi-layered peelable liner to a molded fiber structure, the method comprising:
aligning a multi-layered peelable liner on a first surface corresponding to product contact surface of the molded fiber structure, wherein the multi-layered peelable liner comprises a plurality of polyethylene (PE) layers in a range of 40-65 weight percent (wt. %), a plurality of polyamide (PA) layers in a range of 10 to 25 wt. %, and an ethylene vinyl alcohol (EVOH) layer in a range of 5-25 wt. %;
heating the multi-layered peelable liner using a heating assembly having a plurality of heating elements disposed above the multi-layered peelable liner, wherein a temperature of the plurality of heating elements are maintained at a temperature in a range of 600 degrees Celsius to 800 degrees Celsius; and
applying vacuum suction pressure at a second surface of the molded fiber structure for a suction time of 5-20 seconds such that a suction of the heated multi-layered peelable liner is caused through a plurality of perforations distributed across the molded fiber structure to removably attach and conform the heated multi-layered peelable liner on the first surface, wherein the heating is continued during application of the vacuum suction pressure until the heated multi-layered peelable liner conforms on the first surface.

19. The method according to claim 18, further comprising setting a plurality of different temperatures for different sections the heating assembly for differential heating across the multi-layered peelable liner to allow conformation of the multi-layered peelable liner in accordance with a structure, a shape, a size of each molded fiber structure.

20. The method according to claim 18, wherein a heating duration of the heating the multi-layered peelable liner is a range of 6-12 seconds.
